(19) United States
(12) Patent Application Publication
(10) Pub. No.: US 2024/0087455 A1
(43) Pub. Date: Mar. 14, 2024

(54) SYSTEMS AND METHODS FOR DETERMINING THE OCCUPANCY STATUS OF A PARKING LOT

(71) Applicant: Toyota Motor Engineering & Manufacturing North America, Inc., Plano, TX (US)

(72) Inventors: Takamasa Higuchi, Mountain View, CA (US); Kentaro Oguchi, Mountain View, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 17/942,544

(22) Filed: Sep. 12, 2022

(51) Int. Cl. G08G 1/14; G06N 20/00

(52) U.S. Cl. CPC G08G 1/143; G06N 20/00

(57) ABSTRACT

A system includes a processor and a memory in communication with the processor. The memory has instructions that, when executed by the processor, cause the processor to count, based on sensor data received from vehicles located in a parking lot, the number of non-parked vehicles located in the parking lot within a time period. The instructions further cause the processor to determine an occupancy status of the parking lot based on the number of non-parked vehicles located in the parking lot.

### TECHNICAL FIELD

The subject matter described herein relates, in general, to systems and methods for determining an occupancy status of a parking lot and, more specifically, to determining an occupancy status of a parking lot based on the number of non-parked vehicles located in the parking lot.

### BACKGROUND

The background description provided is to present the context of the disclosure generally. Work of the inventors, to the extent it may be described in this background section, and aspects of the description that may not otherwise qualify as prior art at the time of filing, are neither expressly nor impliedly admitted as prior art against the present technology.

Some current vehicles have sensor systems designed to sense the vehicles' external environment and/or objects located in the external environment, such as nearby vehicles. Moreover, some vehicles may include navigation systems including electronic maps that contain information regarding the location of parking lots. While these electronic maps may provide a driver of a vehicle with directions to a parking lot, the electronic map may not have information regarding the occupancy of the parking lot. As a result, an electronic map may direct a driver of a vehicle to a parking lot that is full or that would require the driver to spend too much time looking for an available parking spot.

In recent developments, some parking lots may include camera systems to capture images of the parking lot. These images may be transmitted to a cloud that may be used to determine when the parking lot is full, for example, based on how many available spots are in the image. However, there may be drawbacks to such systems. For example, installation of such camera systems may be costly, and reliance on these systems requires vehicles to connect to the cloud.

### SUMMARY

This section generally summarizes the disclosure and is not a comprehensive explanation of its full scope or all its features.

In one embodiment, a system is disclosed. The system includes a processor and a memory in communication with the processor. The memory has instructions that, when executed by the processor, cause the processor to count, based on sensor data received from vehicles located in a parking lot, the number of non-parked vehicles located in the parking lot within a time period. The instructions further cause the processor to determine an occupancy status of the parking lot based on the number of non-parked vehicles located in the parking lot.

In another embodiment, a method is disclosed. The method includes the step of counting, based on sensor data received from vehicles located in a parking lot, the number of no-parked vehicles located in the parking lot within a time period. The method further includes the step of determining an occupancy status of the parking lot based on the number of non-parked vehicles located in the parking lot.

In yet another embodiment, a non-transitory computer-readable medium is disclosed. The non-transitory computer-readable medium includes instructions that, when executed by a processor, cause the processor to count, based on sensor data received from vehicles located in a parking lot, the number of non-parked vehicles located in the parking lot within a time period. The instructions further cause the processor to determine an occupancy status of the parking lot based on the number of non-parked vehicles located in the parking lot.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle having a parking lot occupancy detection control system.

FIG. 2 illustrates one embodiment of a parking lot occupancy detection control system.

FIG. 3A illustrates one example of a parking lot having an available occupancy status and a non-parked vehicle located in the parking lot.

FIG. 3B illustrates one example of a parking lot having an unavailable occupancy status and multiple non-parked vehicles located in the parking lot.

FIG. 4 illustrates one embodiment of a parking lot occupancy detection training system.

FIG. 5 illustrates one example of a method of training a machine learning model to be used in the parking lot occupancy detection training system.

FIG. 6 illustrates one example of a method of operating a vehicle having a parking lot occupancy detection control system.

### DETAILED DESCRIPTION

Described are systems and methods for determining the occupancy status of a parking lot. The occupancy status of the parking lot may be determined based on the number of non-parked vehicles located in the parking lot (e.g., the number of vehicles circling in the parking lot). Moreover, a machine learning model may be used to predict the occupancy status of the parking lot based on the number of non-parked vehicles located in the parking lot.

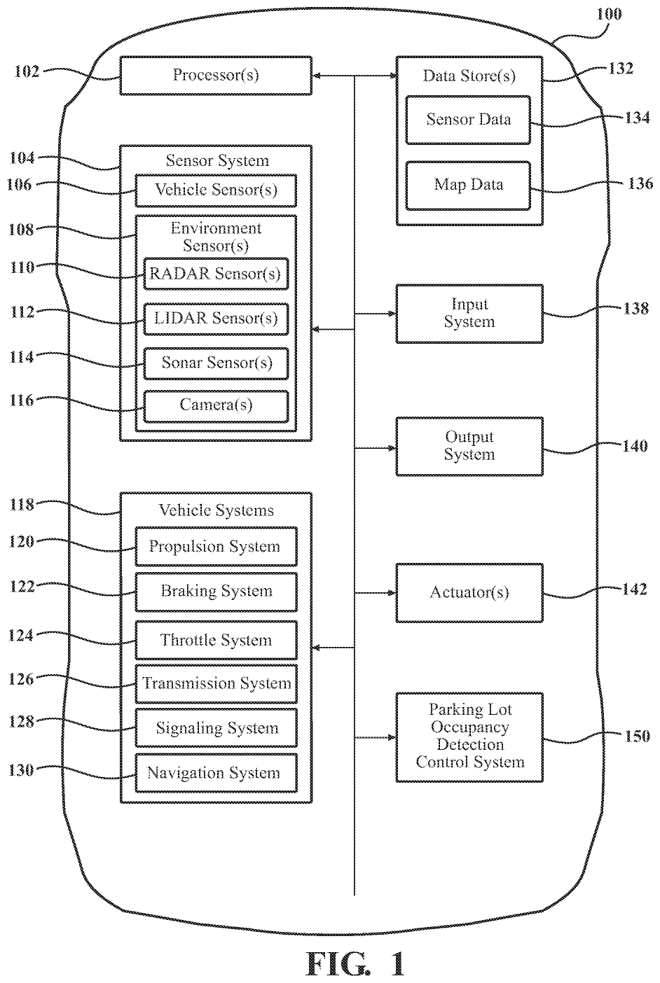

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any robotic device or form of powered transport that, for example, includes one or more automated or autonomous systems, and thus benefits from the functionality discussed herein.

In various embodiments, the automated/autonomous systems or combination of systems may vary. For example, in one aspect, the automated/autonomous systems or combination of systems may vary. For example, in one aspect, the automated system is a system that provides autonomous control of the vehicle 100 according to one or more levels of automation, such as the levels defined by the Society of Automotive Engineers (SAE) (e.g., levels 0-5). As such, the autonomous system may provide semi-autonomous control or fully autonomous control, as discussed in relation to the autonomous driving module.

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

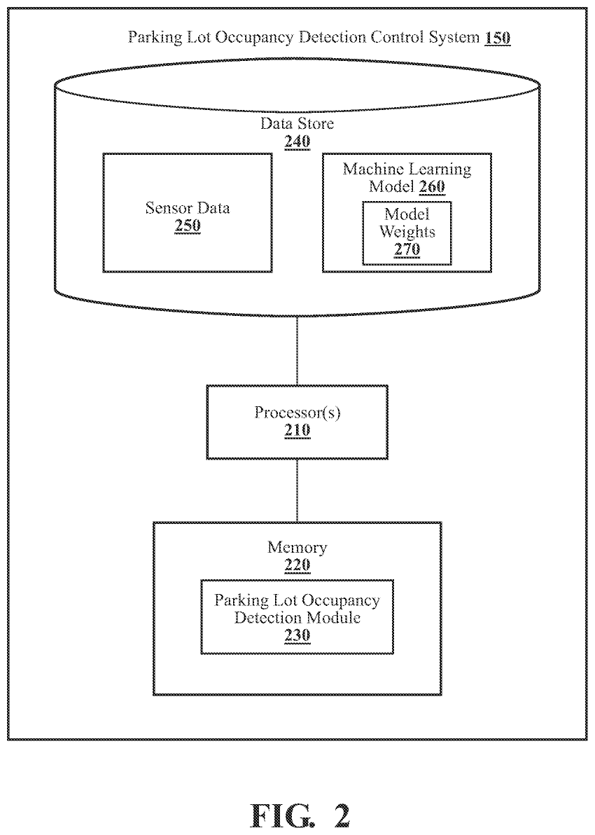

Some of the possible elements of the vehicle 100 are shown in FIG. 1 and will be described along with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

In either case, the vehicle 100 includes a parking lot occupancy detection control system 150. Alternatively, one or more components of the vehicle 100 may access a parking lot occupancy detection control system 150 that is located separately from the vehicle 100. The parking lot occupancy detection control system 150 can be configured to determine an occupancy of a parking lot in which the vehicle 100 is traveling based on a number of nearby vehicles circling in the parking lot. For example, the parking lot occupancy detection control system 150 can be configured to determine if the occupancy status of the parking lot is available or unavailable. If the occupancy status is unavailable, the parking lot occupancy detection control system 150 may be configured to notify a driver of the vehicle 100 and/or recommend a different parking lot to the driver.

Referring now to FIG. 2, one embodiment of a parking lot occupancy detection control system 150 is further illustrated. As shown, the parking lot occupancy detection control system 150 includes a processor 210, which may be a single processor or multiple processors acting in concert. The processor 210 may be a part of the parking lot occupancy detection control system 150, or the parking lot occupancy detection control system 150 may access the processor 210 through a data bus or another communication path. In one or more embodiments, the processor 210 is an application-specific integrated circuit that is configured to implement functions associated with one or more module(s) of the parking lot occupancy detection control system 150.

In general, the processor 210 is an electronic processor, such as a microprocessor, that is capable of performing various functions as described herein. In one embodiment, the parking lot occupancy detection control system 150 includes a memory 220 that stores the module(s). The memory 220 is a random-access memory (RAM), read-only memory (ROM), a hard disk drive, a flash memory, or other suitable memory for storing the module(s). The module(s) are, for example, computer-readable instructions that, when executed by the processor 210, cause the processor 210 to perform the various functions disclosed herein. The module(s) include, for example, a parking lot occupancy detection module 230.

Furthermore, in one embodiment, the parking lot occupancy detection control system 150 includes a data store 240. The data store 240 is, in one embodiment, an electronic data structure such as a database that is stored in the memory 220 or another memory and that is configured with routines that can be executed by the processor 210 for analyzing stored data, providing stored data, organizing stored data, and so on. Thus, in one embodiment, the data store 240 stores data used by the module(s) in executing various functions. In one embodiment, the data store 240 includes sensor data 250, along with, for example, other information that is used by the module(s).

The sensor data 250 may include some or all of the sensor data 134 shown in FIG. 1 and described in further detail below. In one embodiment, the data store 240 also includes a machine learning model 260 along with model weights 270. The machine learning model 260 may be any one of a number of different neural networks that can process the sensor data 250 and output a parking lot occupancy status. The model weights 270 may be one or more model weights that, based on their adjustments, impact how the machine learning model 260 interprets the sensor data 250 and outputs the parking lot occupancy status. Generally, the model weights 270 are the parameters of the machine learning model 260, which are used in the layers of the machine learning model 260. As such, adjustment of the model weights 270 can result in the optimization of the machine learning model 260 such that the machine learning model 260 outputs a more accurate parking lot occupancy status.

Accordingly, the parking lot occupancy detection module 230 generally includes instructions that function to control the processor 210 to operate the parking lot occupancy detection control system 150 based on the sensor data 250 and/or the machine learning model 260. More specifically, the parking lot occupancy detection module 230 includes instructions that function to control the processor 210 to determine an occupancy status of a parking lot 300.

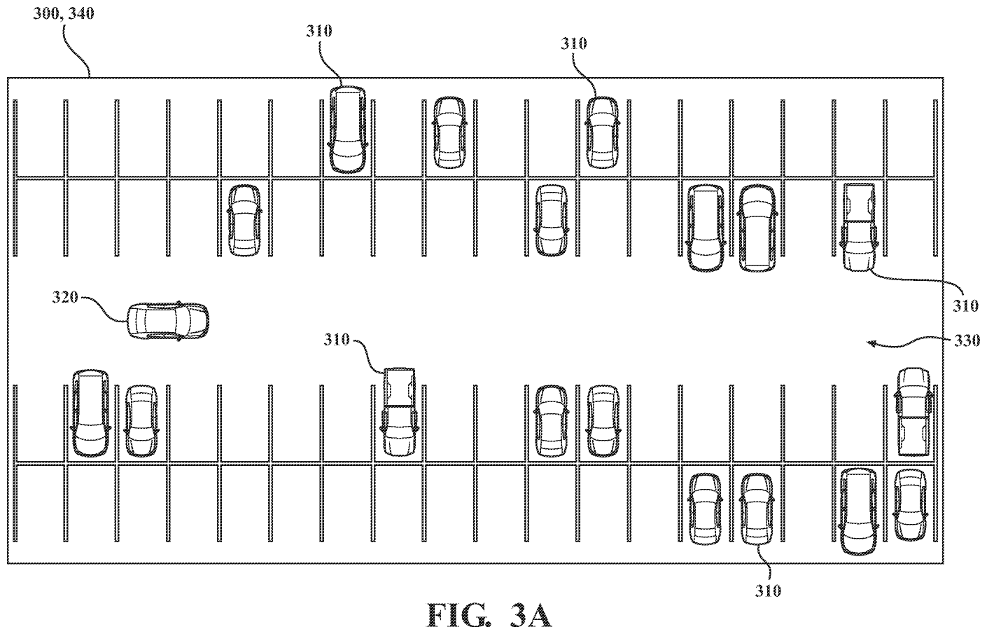

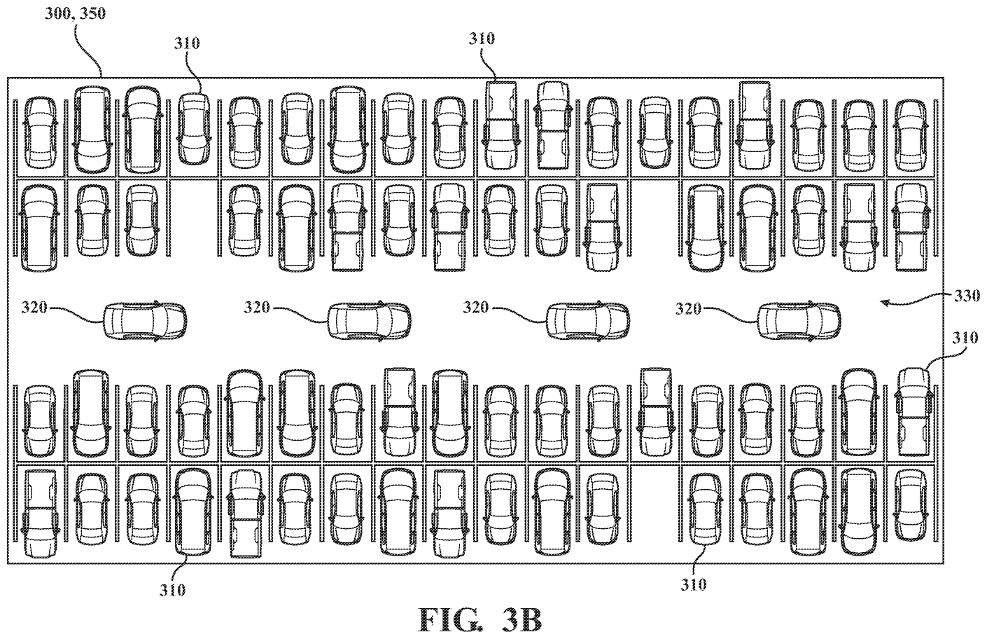

Referring to FIGS. 3A and 3B, the parking lot 300 may be any type of parking lot in which one or more vehicles can park, for example, an indoor parking lot, an outdoor parking lot, a parking garage, a parking structure, a single-level parking lot, a multi-level parking garage, and/or an underground parking lot or garage. The parking lot 300 may include one or more parked vehicles 310 and one or more non-parked vehicles 320. The non-parked vehicles 320 may be vehicles located in the parking lot 300 in a driving lane 330 of the parking lot 300. The drivers of the non-parked vehicles 320 may be driving in the driving lane 330 while searching for an available parking space or may be stopped in the driving lane 330, for example, if they are letting another vehicle exit a parking space. The parking lot occupancy detection module 230 includes instructions that function to control the processor 210 to determine an occupancy status of the parking lot 300 based on the number of non-parked vehicle 320 located in the parking lot 300. In one example, the machine learning model 260 receives the number of non-parked vehicles 320 located in the parking lot 300 and predicts if the parking lot 300 has available parking spots or is occupied.

More specifically, the processor 210 may be configured to receive sensor data 250 from the non-parked vehicles 320. The sensor data 250 may be the sensor data 134 of FIG. 1 and may include camera images, video, LIDAR, sonar, and/or RADAR data, as will be described in further detail below in connection with FIG. 1. The parking lot occupancy detection module 230 may further include instructions that function to control the processor 210 to count, based on the sensor data 250, the number of non-parked vehicles 320 located in the parking lot 300 within a time period. The time period may be any suitable time period. For example, the time period may be a few seconds, a few minutes, or any other suitable time period. Using the number of non-parked vehicles non-parked vehicles 320 located in the parking lot 300 within a time period, the machine learning model 260 can predict if the parking lot 300 has available parking spots or is occupied.

If the processor 210 determines that the occupancy status of the parking lot 300 is unavailable, the parking lot occupancy detection module 230 may further include instructions that function to control the processor 210 to notify the driver and/or recommend a different parking lot to the driver. For example, a notification may be displayed to the driver on an output system 140 located in the vehicle 100, for example, a screen on a center console of the vehicle 100. The notification may inform the driver that the parking lot 300 is unavailable and/or that the driver may have difficulty finding an available parking space. Additionally, or alternatively, the notification may recommend a different parking lot to the driver. For example, the notification may recommend a nearby parking lot, and directions to the nearby parking lot may also be displayed to the driver, for example, using the output system 140.

In some instances, the occupancy status of the parking lot 300 may be predicted based solely on the number of non-parked vehicles 320 detected in the parking lot 300. For example, a machine learning model may be used to predict the occupancy status of the parking lot 300 by training the machine learning model 260 using training data. Accordingly, a parking lot occupancy detection training system 400. The parking lot occupancy detection training system 400 can be configured to train the machine learning model 260 to predict an occupancy status of a parking lot 300 based on the number of non-parked vehicles 320 located in the parking lot 300. This may be done by training the machine learning model 260 using training data having data pairs that may include a historical occupancy status of one or more parking lots corresponding number of non-parked vehicles located in the one or more parking lots. The machine learning model 260 may be trained using the training data to predict the occupancy status of the parking lot 300.

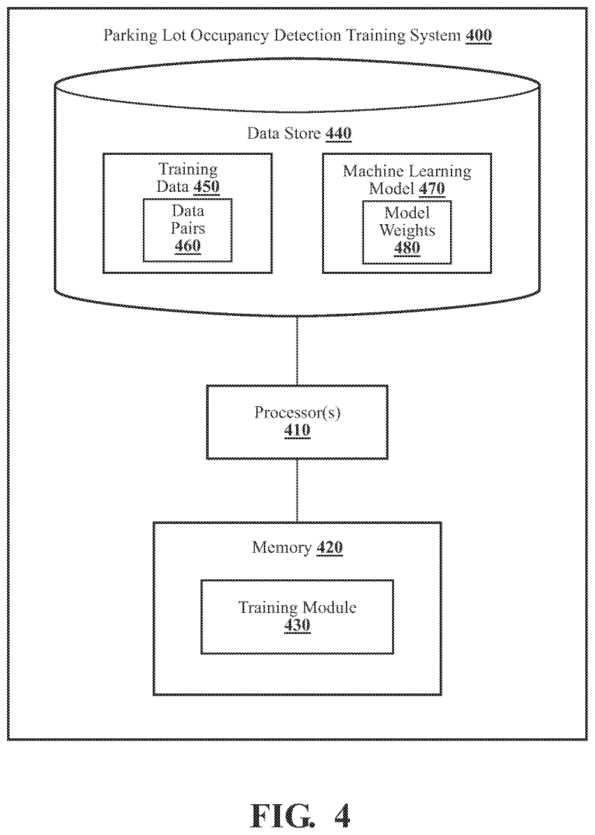

Referring now to FIG. 4, one embodiment of the parking lot occupancy detection training system 400 is further illustrated. As shown, the parking lot occupancy detection training system 400 includes a processor 410. Accordingly, the processor 410 may be a part of the parking lot occupancy detection training system 400, or the parking lot occupancy detection training system 400 may access the processor 410 through a data bus or another communication path. In one or more embodiments, the processor 410 is an application-specific integrated circuit that is configured to implement functions associated with one or more modules of the parking lot occupancy detection training system 400. In general, the processor 410 is an electronic processor, such as a microprocessor, that is capable of performing various functions as described herein. In one embodiment, the parking lot occupancy detection control system 400 includes a memory 420 that stores the module(s). The memory 420 is a random-access memory (RAM), read-only memory (ROM), a hard disk drive, a flash memory, or other suitable memory for storing the module(s). The module(s) are, for example, computer-readable instructions that, when executed by the processor, cause the processor to perform the various functions disclosed herein. The module(s) include, for example, a training module 430.

Furthermore, in one embodiment, the parking lot occupancy detection training system 400 includes a data store 440. The data store 440 is, in one embodiment, an electronic data structure such as a database that is stored in the memory 420 or another memory and that is configured with routines that can be executed by the processor 410 for analyzing stored data, providing stored data, organizing stored data, and so on. Thus, in one embodiment, the data store 440 stores data used by the module(s) in executing various functions. In one embodiment, the data store 440 includes training data 450 that may include data pairs 460. In one embodiment, the data store 440 also includes a machine learning model 470 along with model weights 480. The machine learning model 470 may be the machine learning model 260 associated with the parking lot occupancy detection control system 150 or may be a different machine learning model. The model weights 480 may be the model weights 270 associated with the parking lot occupancy detection control system 150 or may be different model weights. The model weights 480 are adjusted as the machine learning model 470 is trained by the parking lot occupancy detection training system 400.

Accordingly, the training module 430 generally includes instructions that function to control the processor 410 to operate the parking lot occupancy detection training system 400 based on the training data 450. More specifically, the training module 430 includes instructions that function to control the processor 410 to train the machine learning model 470 using the training data 450. As mentioned above, the training data 450 includes data pairs 460. The data pairs 460 include a historical occupancy status of one or more parking lots, such as the parking lot 300, at a given time step and a historical number of non-parked vehicles 320 (in the case of the parking lot 300) located in the parking lot 300 at the given time step.

As mentioned before, the training data 450 may include training pairs that include historical occupancy status of one or more parking lots at a given time step and a historical number of non-parked vehicles located in the parking lot at the given time step. The historical occupancy status of one or more parking lots based on data received from connected vehicles located in the one or more parking lots at the given time step. The data may indicate a number of parking spaces in the parking lot and a number of parked vehicles in the parking lot.

Connected vehicles are essentially vehicles that include sensors that can collect information regarding the one or more parking lots, such as camera sensors, and may be similar to the vehicle 100 shown in for example, these connected vehicles can include environment sensors that include radar, LIDAR, sonar, cameras, or other sensors that can be utilized to detect the number of available spaces as well as occupied spaces in a parking lot. This data collected from the connected vehicles can be then be utilized to generate the training data 450.

The training data 450 and the training pairs 460 include the occupancy status of a parking lot at a given time step in the number of non-parked vehicles located within the parking lot. The occupancy status for the training data can be determined in a number of different ways. For example, the occupancy status can be based on sensor data from the connected vehicles that indicates the ratio of the number of non-parked vehicles to the number of parked vehicles. In the example given in FIG. 3, this would be the number of non-parked vehicles 320 to the number of parked vehicles 310.

Further, in another example, a comparison of the ratio of the number of non-parked vehicles to the number of parked vehicles can be used to determine a predetermined ratio threshold. The predetermined ratio threshold may be based on a size, a location, and/or a purpose of the parking lot. The size, the location, and/or the purpose of the parking lot may influence whether the parking lot should be considered available or unavailable based on the number of non-parked vehicles located in the parking lot. For example, the parking lot 340 located in a downtown area and used for a small family business may be considered unavailable when there is only one non-parked vehicle 320 circling in the parking lot 340. On the other hand, a parking lot 350 lot located in a suburban area and used for a large retail company may be considered unavailable when there are many non-parked vehicles 320 circling in the parking lot 300. Accordingly, based on the number of parked vehicles, the predetermined ratio threshold may be different depending on the size, the location, and/or the purpose of the parking lot. In some instances, the predetermined ratio threshold may be 0.9. However, the predetermined ratio threshold may be any suitable ratio.

The occupancy status of the parking lot can be based on the comparison of the predetermined ratio threshold to the ratio of the number of non-parked vehicles located in the parking lot to the number of parked vehicles in the parking lot. When the ratio is less than the predetermined ratio threshold, it may be determined that the occupancy status of the parking lot is available. As used herein, “available” may mean that a driver may be able to find an available parking space. When the ratio is greater than the predetermined ratio threshold, it may be determined that the occupancy status of the parking lot is unavailable. As used herein, “unavailable” may mean that a driver may need a longer amount of time to find an available parking space, or that there is no available parking space for a driver to utilize. Illustrated examples are shown in FIGS. 3A and 3B. Referring to FIG. 3A, the parking lot 300 may be considered available when there are many more available spaces than non-parked vehicles 320 located in the parking lot 300. Referring to FIG. 3B, the parking lot 300 may be considered unavailable when there are more non-parked vehicles 320 located in the parking lot 300 than available spaces.

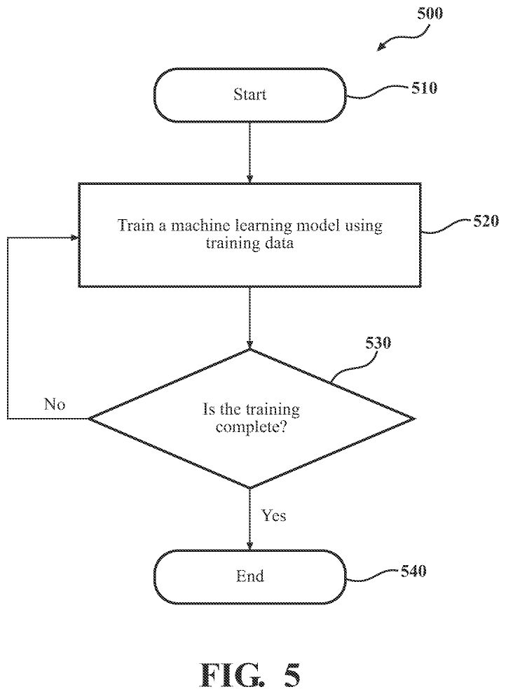

Referring now to FIG. 5, a method 500 for training a parking lot occupancy detection system is shown. The method 500 will be described from the viewpoint of the vehicle 100 of FIG. 1 and the parking lot occupancy detection training system 400 of FIG. 4. However, it should be understood that this is just one example of implementing the method 500. While the method 500 is discussed in combination with the parking lot occupancy detection training system 400, it should be appreciated that the method 500 is not limited to being implemented within the parking lot occupancy detection training system 400 but is instead one example of a system that may implement the method 500.

The method 500 may begin in step 510 and proceed to step 520. In step 520, the method 500 may include training a machine learning model using training data. The machine learning model may be the machine learning model 470 of the parking lot occupancy detection training system 400, and the training data may be the training data 450 associated with the parking lot occupancy detection training system 400. The training data 450 may include data pairs 460 including a historical occupancy status of a parking lot 300 at a given time step and a historical number of non-parked vehicles 320 located in the parking lot 300 at the given time step, and the machine learning model 470 may be configured to predict an occupancy status of the parking lot 300 using the training data 450.

As mentioned before, the training data 450 may include training pairs that include historical occupancy status of one or more parking lots at a given time step and a historical number of non-parked vehicles located in the parking lot at the given time step. The historical occupancy status of one or more parking lots based on data received from connected vehicles located in the one or more parking lots at the given time step. The data may indicate a number of parking spaces in the parking lot and a number of parked vehicles in the parking lot.

In step 530, the method 500 may include determining whether training the machine learning model 470 is complete. The training may be deemed complete once a threshold number of training pairs 460 have been used to train the machine learning model 470 and/or all training data has been utilized. If the training is not complete, the method 500 may return to step 520. If the training is complete, the method 500 may continue to step 540, in which the method 500 ends.

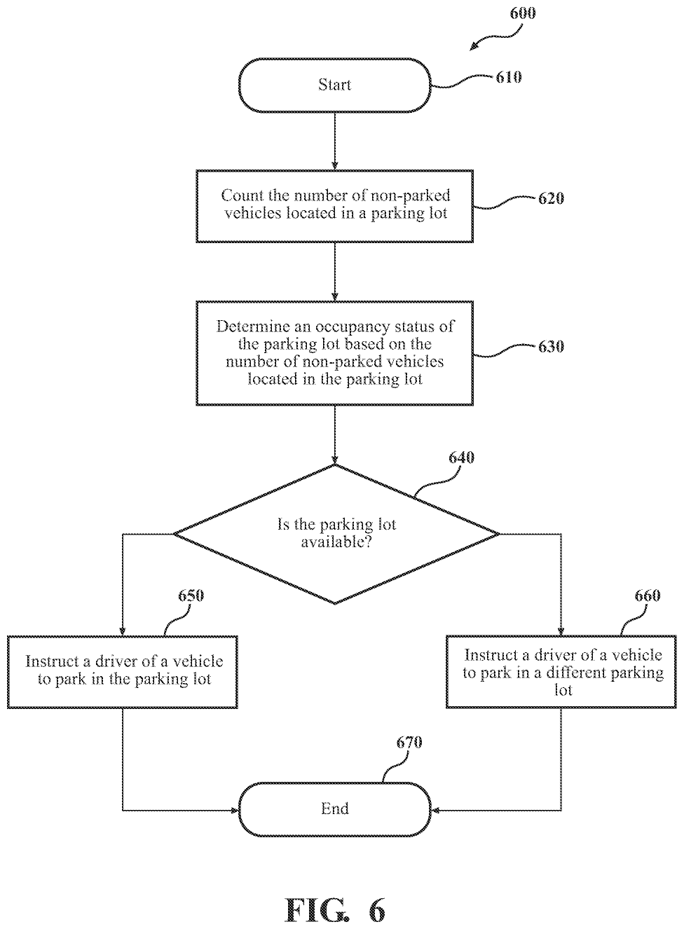

Referring now to FIG. 6, a method 600 for controlling a vehicle is shown. The method 600 will be described from the viewpoint of the vehicle 100 of FIG. 1 and the parking lot occupancy detection control system 150 of FIG. 2. However, it should be understood that this is just one example of implementing the method 600. While the method 600 is discussed in combination with the parking lot occupancy detection control system 150, it should be appreciated that the method 600 is not limited to being implemented within the parking lot occupancy detection control system 150 but is instead one example of a system that may implement the method 600.

The method 600 may begin in step 610 and proceed to step 620. In step 620, the method 600 may include counting the number of non-parked vehicles 320 located in a parking lot 300. The number of non-parked vehicle 320 may be counted based on sensor data received from one or more non-parked vehicles 320 located in the parking lot 300. The sensor data may be the sensor data 250 associated with the parking lot occupancy detection control system 150. In step 630, the method 600 may include determining an occupancy status of the parking lot 300 based on the number of non-parked vehicle 320 located in the parking lot 300. For example, the occupancy status may be predicted using a machine learning model, as described above in connection with FIGS. 4 and 5. The machine learning model may be the machine learning model 260 associated with the parking lot occupancy detection control system 150.

The method 600 may continue to step 640, in which the method 600 determines whether the parking lot 300 is available based on the occupancy status. If the parking lot 300 is available, the method 600 continues to step 650, in which the method 600 includes instructing a driver of a vehicle 100 to park in the parking lot 300. If the parking lot 300 is not available, the method 600 continues to step 660, in which the method 600 includes notifying a driver of a vehicle 100 that the parking lot 300 is unavailable and/or instructing a driver of a vehicle 100 to park in a different parking lot. After step 650 or step 660, the method 600 may proceed to step 670 in which the method 600 ends.

FIG. 1 will now be discussed in full detail as an example environment within which the system and methods disclosed herein may operate. The vehicle 100 can include one or more processors 102. In one or more arrangements, the processor(s) 102 can be a main processor of the vehicle 100. For instance, the processor(s) 102 can be an electronic control unit (ECU). The vehicle 100 can also include one or more data stores 132 for storing one or more types of data. The data store(s) 132 can include volatile and/or non-volatile memory. Examples of suitable data stores include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 132 can be a component of the processor(s) 102, or the data store(s) 132 can be operatively connected to the processor(s) 102 for use thereby. The term “operatively connected,” as used throughout this description, can include direct or indirect connections, including connections without direct physical contact.

In one or more arrangements, the data store(s) 132 can include sensor data 134. In this context, “sensor data” means any information about sensors that the vehicle 100 is equipped with, including the capabilities and other information about such sensors. As will be explained below, the vehicle 100 can include a sensor system 104. The sensor data 134 can relate to one or more sensors of the sensor system 104. In one or more arrangements, the data store(s) 132 can also include map data 136. The map data 136 can include maps of one or more geographic areas. In some instances, the map data 136 can include information or data on roads, traffic control devices, road markings, structures, features, landmarks, and/or parking lots in the one or more geographic areas. The map data 136 can be in any suitable form. In some instances, the map data 136 can include aerial views of an area. In some instances, the map data 136 can include ground views of an area, including 360-degree ground views. The map data 136 can include measurements, dimensions, distances, and/or information for one or more items included in the map data 136 and/or relative to other items included in the map data 136. The map data 136 can include a digital map with information about road geometry. The map data 136 can be high quality and/or highly detailed. In some instances, at least a portion of the sensor data 134 and/or the map data 136 can be located in the data store(s) 132 located onboard the vehicle 100. Alternatively, or in addition, at least a portion of the sensor data 134 and/or the map data 136 can be located in one or more data stores that are located remotely from the vehicle 100.

As noted above, the vehicle 100 can include the sensor system 104. The sensor system 104 can include one or more sensors. “Sensor” means any device, component and/or system that can detect, and/or sense something. The sensors can be configured to detect and/or sense in real-time. As used herein, the term “real-time” means a level of processing responsiveness that a user or system senses as sufficiently immediate for a particular process or determination to be made, or that enables the processor to keep up with some external process. In arrangements in which the sensor system 104 includes a plurality of sensors, the sensors can work independently from each other. Alternatively, two or more of the sensors can work in combination with each other. In such a case, the two or more sensors can form a sensor network. The sensor system 104 and/or the one or more sensors can be operatively connected to the processor(s) 102, the data store(s) 132, and/or another element of the vehicle 100 (including any of the elements shown in FIG. 1). The sensor system 104 can acquire data of at least a portion of the external environment of the vehicle 100 (e.g., nearby vehicles).

The sensor system 104 can include any suitable type of sensor. Various examples of different types of sensors will be described herein. However, it will be understood that the embodiments are not limited to the particular sensors described. The sensor system 104 can include one or more vehicle sensors 106. The vehicle sensor(s) 106 can detect, determine, and/or sense information about the vehicle 100 itself. In one or more arrangements, the vehicle sensor(s) 106 can be configured to detect and/or sense position and orientation changes of the vehicle 100, such as, for example, based on inertial acceleration. In one or more arrangements, the vehicle sensor(s) 106 can include one or more speedometers, one or more accelerometers, one or more gyroscopes, an inertial measurement unit (IMU), a dead-reckoning system, a global navigation satellite system (GNSS), a global positioning system (GPS), a navigation system, and/or other suitable sensor. The vehicle sensor(s) 106 can be configured to detect and/or sense one or more characteristics of the vehicle 100.

Alternatively, or in addition, the sensor system 104 can include one or more environment sensors 108 configured to acquire and/or sense driving environment data. “Driving environment data” includes data or information about the external environment in which the vehicle 100 is located or one or more portions thereof. For example, the one or more environment sensors can be configured to detect, quantify, and/or sense obstacles in at least a portion of the external environment of the vehicle 100 and/or information/data about such obstacles. Such obstacles may be stationary objects and/or dynamic objects. The one or more environment sensors can be configured to detect, measure, quantify, and/or sense other things in the external environment of the vehicle 100, such as, for example, nearby vehicles, lane markers, signs, traffic lights, traffic signs, lane lines, crosswalks, curbs proximate the vehicle 100, off-road objects, etc.

Various examples of sensors of the sensor system 104 will be described herein. The example sensors may be part of the one or more environment sensors 108 and/or the one or more vehicle sensors 106. However, it will be understood that the embodiments are not limited to the particular sensors described. As an example, in one or more arrangements, the sensor system 104 can include one or more radar sensors 110, one or more LIDAR sensors 112, one or more sonar sensors 114, and/or one or more cameras 116. In one or more arrangements, the one or more cameras 116 can be high dynamic range (HDR) cameras or infrared (IR) cameras.

The vehicle 100 can include one or more vehicle systems 118. Various examples of the vehicle systems 118 are shown in FIG. 1. However, the vehicle 100 can include more, fewer, or different vehicle systems 118. It should be appreciated that although particular vehicle systems 118 are separately defined, each or any of the systems or portions thereof may be otherwise combined or segregated via hardware and/or software within the vehicle 100. The vehicle 100 can include a propulsion system 120, a braking system 122, a throttle system 124, a transmission system 126, a signaling system 128, and/or a navigation system 130. Each of these vehicle systems 118 can include one or more devices, components, and/or a combination thereof, now known or later developed.

The navigation system 130 can include one or more devices, applications, and/or combinations thereof, now known or later developed, configured to determine the geographic location of the vehicle 100 and/or to determine a travel route for the vehicle 100. The navigation system 130 can include one or more mapping applications to determine a travel route for the vehicle 100, for example, a travel route to a parking lot. The navigation system 130 can include a global positioning system, a local positioning system, or a geolocation system.

The vehicle 100 can include an input system 138. An “input system” includes any device, component, system, element or arrangement or groups thereof that enable information/data to be entered into a machine. The input system 138 can receive an input from a vehicle passenger (e.g., a driver or a passenger). The vehicle 100 can include an output system 140. An “output system” includes any device, component, or arrangement or groups thereof that enable information/data to be presented to a vehicle passenger (e.g., a person, a vehicle 100 passenger, etc.). In some instances, the input system 138 and the output system 140 may be the same component, such as a screen in a center console of the vehicle 100. The input system 138 and/or the output system 140 may be configured to display directions to a parking lot to a driver of the vehicle 100, as described above.

The vehicle 100 can include one or more actuators 142. The actuators 142 can be any element or combination of elements operable to modify, adjust, and/or alter one or more of the vehicle systems 118 or components thereof to responsive to receiving signals or other inputs from the processor(s) 102. Any suitable actuator can be used. For instance, the one or more actuators 142 can include motors, pneumatic actuators, hydraulic pistons, relays, solenoids, and/or piezoelectric actuators, just to name a few possibilities.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory in communication with the processor, the memory having instructions that, when executed by the processor, cause the processor to:
count, based on sensor data received from vehicles located in a parking lot, the number of non-parked vehicles located in the parking lot within a time period; and
determine an occupancy status of the parking lot based on the number of non-parked vehicles located in the parking lot.

2. The system of claim 1, wherein the instructions further cause the processor to determine the occupancy status of the parking lot using a machine learning model, wherein the machine learning model predicts the occupancy status of the parking lot based on the number of non-parked vehicles located in the parking lot.

3. The system of claim 2, wherein the instructions further cause the processor to train the machine learning model using training data, the training data having data pairs, wherein the data pairs include a historical occupancy status of the parking lot at a given time step and a historical number of non-parked vehicles located in the parking lot at the given time step.

4. The system of claim 3, wherein the instructions further cause the processor to determine the historical occupancy status of the parking lot based on data received from connected vehicles located in the parking lot at the given time step, the data indicating a number of parking spaces in the parking lot and a number of parked vehicles in the parking lot.

5. The system of claim 4, wherein the instructions further cause the processor to:
compare the ratio of the number of parking spaces in the parking lot and the number of parked vehicles in the parking lot to a predetermined ratio threshold, wherein the predetermined ratio threshold is based on at least one of the size, location, and purpose of the parking lot; and
determine at least one of:
the occupancy status of the parking lot is available when the ratio is less than the predetermined ratio threshold; and
the occupancy status of the parking lot is occupied when the ratio is greater than the predetermined ratio threshold.

6. The system of claim 5, wherein the instructions further cause the processor to recommend a different parking lot to a driver of a vehicle when the occupancy status of the parking lot is occupied.

7. The system of claim 1, wherein the instructions further cause the processor to determine the occupancy status of the parking lot using historical data, wherein the historical data include entries that associate the occupancy status of the parking lot with the number of non-parked vehicles located in the parking lot.

8. A method comprising steps of:
counting, based on sensor data received from vehicles located in a parking lot, the number of non-parked vehicles located in the parking lot within a time period;
determining an occupancy status of the parking lot based on the number of non-parked vehicles located in the parking lot.

9. The method of claim 8, further comprising the step of determining the occupancy status of the parking lot using a machine learning model, wherein the machine learning model predicts the occupancy status of the parking lot based on the number of non-parked vehicles located in the parking lot.

10. The method of claim 9, further comprising the step of training the machine learning model using training data, the training data having data pairs, wherein the data pairs include a historical occupancy status of the parking lot at a given time step and a historical number of non-parked vehicles located in the parking lot at the given time step.

11. The method of claim 10, further comprising the step of determining the historical occupancy status of the parking lot based on data received from connected vehicles located in the parking lot at the given time step, the data indicating a number of parking spaces in the parking lot and a number of parked vehicles in the parking lot.

12. The method of claim 11, further comprising the step of:
comparing the ratio of the number of parking spaces in the parking lot and the number of parked vehicles in the parking lot to a predetermined ratio threshold, wherein the predetermined ratio threshold is based on at least one of the size, location, and purpose of the parking lot; and at least one of the steps of:
determining that the occupancy status of the parking lot is available when the ratio is less than the predetermined ratio threshold; and
determining that the occupancy status of the parking lot is occupied when the ratio is greater than the predetermined ratio threshold.

13. The method of claim 12, further comprising the step of determining the occupancy status of the parking lot using historical data, wherein the historical data include entries that associate the occupancy status of the parking lot with the number of non-parked vehicles located in the parking lot.

14. The method of claim 8, further comprising the step of recommending a different parking lot to a driver of a vehicle when the occupancy status of the parking lot is occupied.

15. A non-transitory computer-readable medium having instructions that, when executed by a processor, cause the processor to:
count, based on sensor data received from vehicles located in a parking lot, the number of non-parked vehicles located in the parking lot within a time period; and
determine an occupancy status of the parking lot based on the number of non-parked vehicles located in the parking lot.

16. The non-transitory computer-readable medium of claim 15, further having instructions that, when executed by the processor, cause the processor to determine the occupancy status of the parking lot using a machine learning model, wherein the machine learning model predicts the occupancy status of the parking lot based on the number of non-parked vehicles located in the parking lot.

17. The non-transitory computer-readable medium of claim 16, further having instructions that, when executed by the processor, cause the processor to train the machine learning model using training data, the training data having data pairs, wherein the data pairs include a historical occupancy status of the parking lot at a given time step and a historical number of non-parked vehicles located in the parking lot at the given time step.

18. The non-transitory computer-readable medium of claim 17, further having instructions that, when executed by the processor, cause the processor to determine the historical occupancy status of the parking lot based on data received from connected vehicles located in the parking lot at the given time step, the data indicating a number of parking spaces in the parking lot and a number of parked and non-parked vehicles in the parking lot.

19. The non-transitory computer-readable medium of claim 18, further having instructions that, when executed by the processor, cause the processor to:
compare the ratio of the number of parking spaces in the parking lot and the number of parked vehicles in the parking lot to a predetermined ratio threshold, wherein the predetermined ratio threshold is based on at least one of the size, location, and purpose of the parking lot; and
determine at least one of:
the occupancy status of the parking lot is available when the ratio is less than the predetermined ratio threshold; and
the occupancy status of the parking lot is occupied when the ratio is greater than the predetermined ratio threshold.

20. The non-transitory computer-readable medium of claim 15, further having instructions that, when executed by the processor, cause the processor to determine the occupancy status of the parking lot using historical data, wherein the historical data include entries that associate the occupancy status of the parking lot with the number of non-parked vehicles located in the parking lot.
